(19) United States
(12) Patent Application Publication
(10) Pub. No.: US 2008/0059283 A1
(43) Pub. Date: Mar. 6, 2008

(54) Method and system for opportunity distribution

(75) Inventors: Erik Beck Hansen, San Jose, CA (US); Massimiliano Mancini, San Jose, CA (US); R. Todd Miner, Palo Alto, CA (US)

Correspondence Address: SCHWEGMAN, LUNDBERG & WOESSNER, P.A., P.O. BOX 2938, MINNEAPOLIS, MN, 55402, US

(73) Assignee: eBay Inc.

(21) Appl. No.: 11/513,926

(22) Filed: Aug. 31, 2006

(51) Int. Cl. G07G 1/00

(52) U.S. Cl. 705/10

(57) ABSTRACT

A method and system for opportunity distribution. Respective first and second groups of users are identified. An opportunity is provided to the first group of users. A trigger event is detected. The opportunity is selectively provided to the second group of users based on the detection of the trigger event.

### FIELD

The present application relates generally to the technical field of data-communication and, in one specific example, to a method and system for opportunity distribution.

### BACKGROUND

When a computer user seeks to notify different groups of people regarding an opportunity such as an event or an item for sale, the computer user typically sends one or more e-mails to friends and/or acquaintances and posts messages in select areas such as on message boards. The user may sporadically send out the opportunity over a long period of time, or may provide a single communication or a series of communications over a short period of time.

### BRIEF DESCRIPTION OF THE DRAWINGS

Some embodiments are illustrated by way of example and not limitation in the figures of the accompanying drawings in which:

FIG. 1 is a network diagram depicting a network system, according to one embodiment, having a client server architecture to exchange data over a network;

FIG. 2 is a block diagram illustrating an example embodiment of multiple network and marketplace applications, which are provided as part of the network-based marketplace;

FIG. 3 is a block diagram of an example network marketplace module;

FIG. 4 is a flowchart illustrating a method of opportunity distribution according to an example embodiment;

FIG. 5 is a flowchart illustrating a method of target selection according to an example embodiment;

FIG. 6 is a flowchart illustrating a method of opportunity distribution according to an example embodiment;

FIG. 7 is a flowchart illustrating a method for obtaining a contact list according to an example embodiment;

FIG. 8 is a flowchart illustrating a method of communication type selection according to an example embodiment;

FIG. 9 is a flowchart illustrating a method to define a mixed module communication type according to an example embodiment;

FIG. 10 is a flowchart illustrating an example method to provide communication to target groups of users according to trigger criteria;

FIG. 11 is a flowchart illustrating an example method to provide communication to target groups of users according to trigger criteria;

FIG. 12 is a flowchart illustrating a method to provide communication to a target group of users according to an example embodiment;

FIG. 13 is a flowchart illustrating a method to provide price communication to a target group of users according to an example embodiment;

FIG. 14 is a block diagram of an example user interface

FIG. 15 is a block diagram of an example user interface; and

FIG. 16 is a block diagram diagrammatic representation of machine in the example form of a computer system within which a set of instructions, for causing the machine to perform any one or more of the methodologies discussed herein, may be executed.

### DETAILED DESCRIPTION

Example methods and systems for opportunity distribution are described. In the following description, for purposes of explanation, numerous specific details are set forth in order to provide a thorough understanding of example embodiments. It will be evident, however, to one skilled in the art that the present invention may be practiced without these specific details.

A method and system may be used for opportunity distribution by a communication. A number of target groups (e.g., a group of users) of users may first be identified. Targets may then be selected for the target groups of users, where the targets may be selected from contact lists and/or contact areas. A communication type may be selected for the target groups of users to specify a type of communication to be distributed. A communication of the communication type may then be provided to the target groups of users.

The method and system for opportunity distribution may provide an opportunity to select a first group of users and then a second group of users based on a trigger event. The selection of the first group of users and the second group of users may enable specification of when a particular group may have access to the communication.

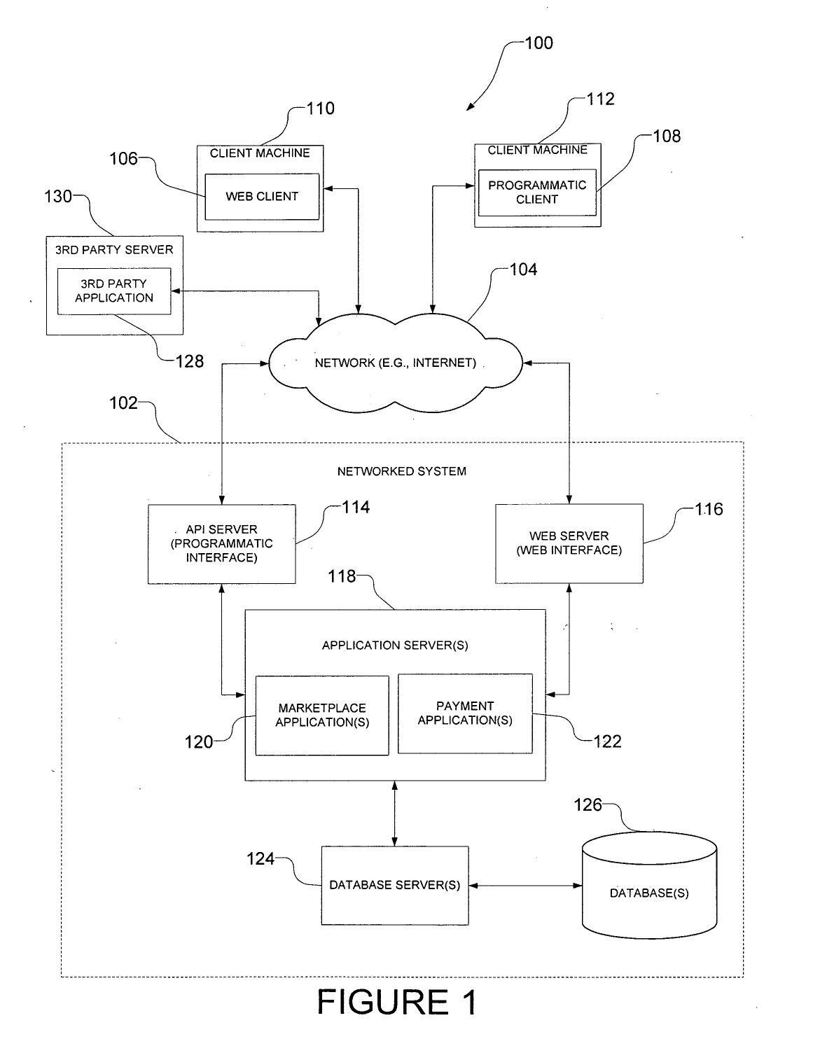

FIG. 1 is a network diagram depicting a client-server system 100, within which one example embodiment may be deployed. A networked system 102, in the example forms of a network-based marketplace or publication system, provides server-side functionality, via a network 104 (e.g., the Internet or Wide Area Network (WAN)) to one or more clients. FIG. 1 illustrates, for example, a web client 106 (e.g., a browser, such as the Internet Explorer browser developed by Microsoft Corporation of Redmond, Wash. State), and a programmatic client 108 executing on respective client machines 110 and 112.

An Application Program Interface (API) server 114 and a web server 116 are coupled to, and provide programmatic and web interfaces respectively to, one or more application servers 118. The application servers 118 host one or more marketplace applications 120 and payment applications 122. The application servers 118 are, in turn, shown to be coupled to one or more databases servers 124 that facilitate access to one or more databases 126.

The marketplace applications 120 may provide a number of marketplace functions and services to users that access the networked system 102. The payment applications 122 may likewise provide a number of payment services and functions to users. The payment applications 122 may allow users to accumulate value (e.g., in a commercial currency, such as the U.S. dollar, or a proprietary currency, such as “points”) in accounts, and then later to redeem the accumulated value for items (e.g., products or services) that are made available via the marketplace applications 120. While the marketplace and payment applications 120 and 122 are shown in FIG. 1 to both form part of the networked system 102, it will be appreciated that, in alternative embodiments, the payment applications 122 may form part of a payment service that is separate and distinct from the networked system 102.

Further, while the system 100 shown in FIG. 1 employs a client-server architecture, the present invention is of course not limited to such an architecture, and could equally well find application in a distributed, or peer-to-peer, architecture system, for example. The various marketplace and payment applications 120 and 122 could also be implemented as standalone software programs, which do not necessarily have networking capabilities.

The web client 106 accesses the various marketplace and payment applications 120 and 122 via the web interface supported by the web server 116. Similarly, the programmatic client 108 accesses the various services and functions provided by the marketplace and payment applications 120 and 122 via the programmatic interface provided by the API server 114. The programmatic client 108 may, for example, be a seller application (e.g., the TurboLister application developed by eBay Inc., of San Jose, Calif.) to enable sellers to author and manage listings on the networked system 102 in an off-line manner, and to perform batch-mode communications between the programmatic client 108 and the networked system 102.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more promotional, marketplace or payment functions that are supported by the relevant applications of the networked system 102.

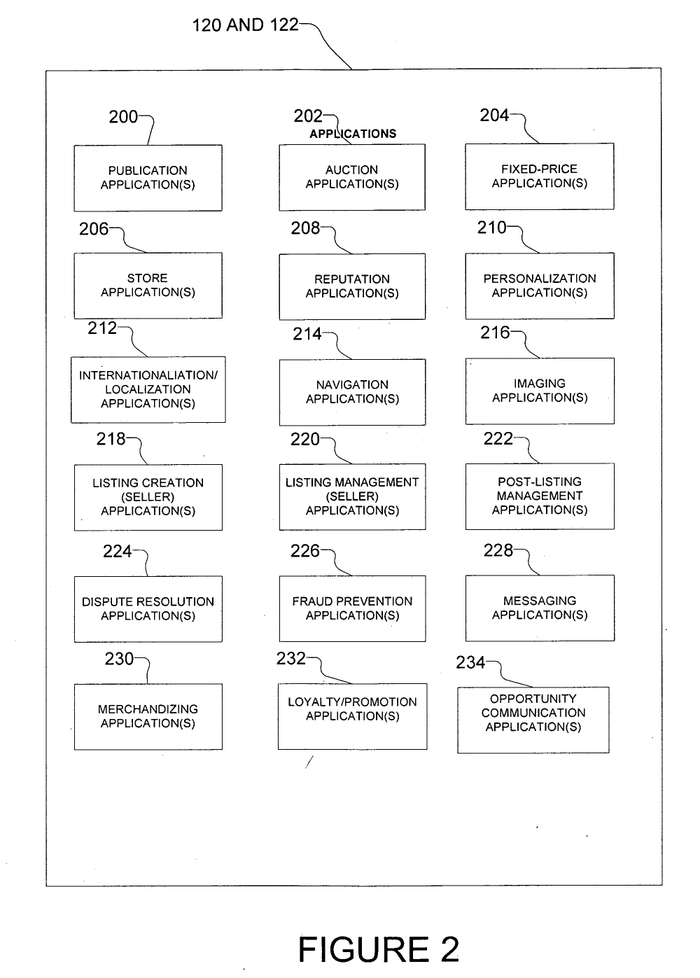

FIG. 2 is block diagram illustrating multiple applications 120 and 122 that, in one example embodiment, are provided as part of the networked system 102. The applications 120 may be hosted on dedicated or shared server machines (not shown) that are communicatively coupled to enable communications between server machines. The applications themselves are communicatively coupled (e.g., via appropriate interfaces) to each other and to various data sources, so as to allow information to be passed between the applications or so as to allow the applications to share and access common data. The applications may furthermore access server one or more databases 126 via the database servers 128.

The networked system 102 may provide a number of publishing, listing and price-setting mechanisms whereby a seller may list (or publish information concerning) goods or services for sale, a buyer can express interest in or indicate a desire to purchase such goods or services, and a price can be set for a transaction pertaining to the goods or services. To this end, the marketplace applications 120 are shown to include at least one publication application 200 and one or more auction applications 202 which support auction-format listing and price setting mechanisms (e.g., English, Dutch, Vickrey, Chinese, Double, Reverse auctions etc.). The various auction applications 202 may also provide a number of features in support of such auction-format listings, such as a reserve price feature whereby a seller may specify a reserve price in connection with a listing and a proxy-bidding feature whereby a bidder may invoke automated proxy bidding.

A number of fixed-price applications 204 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with auction-format listings, and allow a buyer to purchase goods or services, which are also being offered for sale via an auction, for a fixed-price that is typically higher than the starting price of the auction.

Store applications 206 allow a seller to group listings within a “virtual” store, which may be branded and otherwise personalized by and for the seller. Such a virtual store may also offer promotions, incentives and features that are specific and personalized to a relevant seller.

Reputation applications 208 allow users that transact, utilizing the networked system 102, to establish, build and maintain reputations, which may be made available and published to potential trading partners. Consider that where, for example, the networked system 102 supports person-to-person trading, users may otherwise have no history or other reference information whereby the trustworthiness and credibility of potential trading partners may be assessed. The reputation applications 208 allow a user, for example through feedback provided by other transaction partners, to establish a reputation within the networked system 102 over time. Other potential trading partners may then reference such a reputation for the purposes of assessing credibility and trustworthiness.

Personalization applications 210 allow users of the networked system 102 to personalize various aspects of their interactions with the networked system 102. For example a user may, utilizing an appropriate personalization application 210, create a personalized reference page at which information regarding transactions to which the user is (or has been) a party may be viewed. Further, a personalization application 210 may enable a user to personalize listings and other aspects of their interactions with the networked system 102 and other parties.

The networked system 102 may support a number of marketplaces that are customized, for example, for specific geographic regions. For example, a version of the networked system 102 may be customized for the United Kingdom, whereas another version of the networked system 102 may be customized for the United States. By way of another example, a version of the networked system 102 may be customized for a local market such as a city or shopping center for a location like San Jose, Calif. Each of these versions may operate as an independent marketplace, or may be customized (or internationalized and/or localized) presentations of a common underlying marketplace. The networked system 102 may accordingly include a number of internationalization and/or localization applications 212 that customize information (and/or the presentation of information) by the networked system 102 according to predetermined criteria (e.g., geographic, demographic or marketplace criteria). For example, the internationalization and/or localization applications 212 may be used to support the customization of information for a number of regional websites that are operated by the networked system 102 and that are accessible via respective web servers 116.

Navigation of the networked system 102 may be facilitated by one or more navigation applications 214. For example, a search application (as an example of a navigation application) may enable key word searches of listings published via the networked system 102. A browse application may allow users to browse various category, catalogue, or inventory data structures according to which listings may be classified within the networked system 102. Various other navigation applications may be provided to supplement the search and browsing applications.

In order to make listings, available via the networked system 102, as visually informing and attractive as possible, the marketplace applications 120 may include one or more imaging applications 216 utilizing which users may upload images for inclusion within listings. An imaging application 216 also operates to incorporate images within viewed listings. The imaging applications 216 may also support one or more promotional features, such as image galleries that are presented to potential buyers. For example, sellers may pay an additional fee to have an image included within a gallery of images for promoted items.

Listing creation applications 218 allow sellers conveniently to author listings pertaining to goods or services that they wish to transact via the networked system 102, and listing management applications 220 allow sellers to manage such listings. Specifically, where a particular seller has authored and/or published a large number of listings, the management of such listings may present a challenge. The listing management applications 220 provide a number of features (e.g., auto-relisting, inventory level monitors, etc.) to assist the seller in managing such listings. One or more post-listing management applications 222 also assist sellers with a number of activities that typically occur post-listing. For example, upon completion of an auction facilitated by one or more auction applications 202, a seller may wish to leave feedback regarding a particular buyer. To this end, a post-listing management application 222 may provide an interface to one or more reputation applications 208, so as to allow the seller conveniently to provide feedback regarding multiple buyers to the reputation applications 208.

Dispute resolution applications 224 provide mechanisms whereby disputes arising between transacting parties may be resolved. For example, the dispute resolution applications 224 may provide guided procedures whereby the parties are guided through a number of steps in an attempt to settle a dispute. In the event that the dispute cannot be settled via the guided procedures, the dispute may be escalated to a third party mediator or arbitrator.

A number of fraud prevention applications 226 implement fraud detection and prevention mechanisms to reduce the occurrence of fraud within the networked system 102.

Messaging applications 228 are responsible for the generation and delivery of messages to users of the networked system 102, such messages for example advising users regarding the status of listings at the networked system 102 (e.g., providing “outbid” notices to bidders during an auction process or to provide promotional and merchandising information to users). Respective messaging applications 228 may utilize any one have a number of message delivery networks and platforms to deliver messages to users. For example, messaging applications 228 may deliver electronic mail (e-mail), instant message (IM), multimedia messaging server (MMS), Short Message Service (SMS), text, facsimile, or voice (e.g., Voice over IP (VoIP)) messages via the wired (e.g., the Internet), Plain Old Telephone Service (POTS), or wireless (e.g., mobile, cellular, WiFi, WiMAX) networks.

Merchandising applications 230 support various merchandising functions that are made available to sellers to enable sellers to increase sales via the networked system 102. The merchandising applications 80 also operate the various merchandising features that may be invoked by sellers, and may monitor and track the success of merchandising strategies employed by sellers.

The networked system 102 itself, or one or more parties that transact via the networked system 102, may operate loyalty programs that are supported by one or more loyalty/promotions applications 232. For example, a buyer may earn loyalty or promotions points for each transaction established and/or concluded with a particular seller, and may be offered a reward for which accumulated loyalty points can be redeemed.

Opportunity communication applications 234 may enable communication among users of the networked system 102 and outside of the networked system 102 regarding opportunities such as information or offers of goods/services to buy, sell, for auction or combinations of the foregoing. In an example embodiment, the opportunity communication applications 234 may utilize the messaging applications 228 for communication.

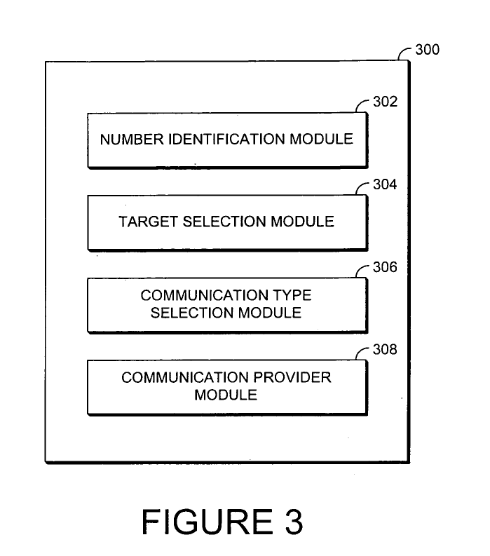

Referring to FIG. 3, an opportunity communication application 300 according to an example embodiment is shown. The opportunity communication application 300 may include a number identification module 302, a target selection module 304, a communication type selection module 306 and a communication provider module 308. However, it should be appreciated that the functionality of the modules 300-308 may be merged into or split among one or more modules.

The number identification module 302 may identify a number of target groups of users, wherein each target group of users may include selected targets (e.g., groups of users) to whom a communication regarding an opportunity is intended. In an example embodiment, each target group of users may define an increasing (or decreasing) number of users to have access to the opportunity. In an example embodiment, each target group of users may define a different group of users to have access to the opportunity. In an example embodiment, the use of more than one channel may enable the migration of a purchase opportunity from a marketplace of a first size and/or type to a second size and/or type (e.g., from a limited marketplace to a marketplace of more general appeal).

In an example embodiment, the communication may be a message. In an example embodiment, the communication may be a posting.

The target selection module 304 may identify targets for the target groups of users. For example, the targets may include users of contact lists (e.g., groups of users and market places) and/or users within contact areas (e.g., geographic locations). The targets for the target groups of users may be selected to enable a first group of users access to an opportunity before a second group of users. Example embodiments of contact lists and contact areas are described in greater detail below.

The communication type selection module 306 may select a communication type for the target groups of users. For example, the one or more communication types may include one or more notification communication types, sale communication types, buy communication types, auction communication types and/or mixed-mode communication types.

The communication provider module 308 may provide communications for the target groups of users. The communications may provide an opportunity for a user, such as a notification with information of potential interest to a user, an offer to buy, an offer to sell, an auction notification, and the like.

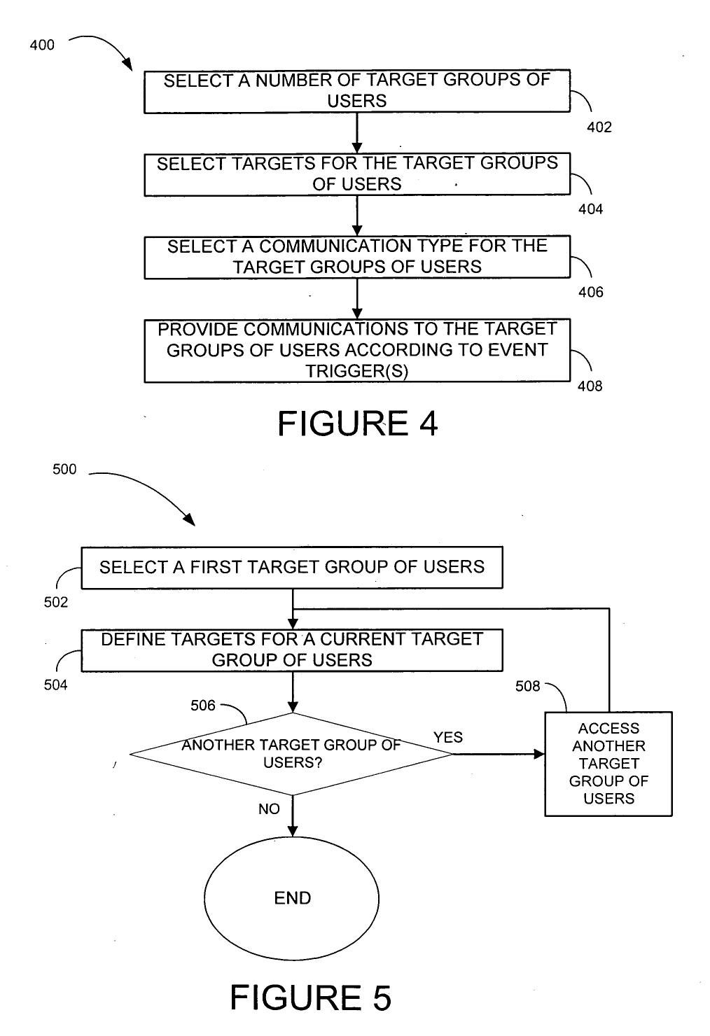

Referring to FIG. 4, a method 400 of opportunity distribution in accordance with an example embodiment is shown. In an example embodiment, the opportunity communication applications 234 (see FIG. 2) may operate the method 400.

A number of target groups of users may be selected at block 402. In an example embodiment, at least two target groups of users may be selected at block 402. Targets (e.g., groups of users) may then be selected for the target groups of users at block 404. An example embodiment for target selection is described in greater detail below.

A communication type may be selected for the target groups of users at block 406. An example embodiment for communication type selection is described in greater detail below.

Communications may be provided to the target groups of users according to one or more trigger events at block 408. In an example embodiment, the communication may be provided to a first target group of users and upon detection of the trigger event the communication may be provided to a second target group of users. In an example embodiment, a communication may be provided to targets of each of the target groups of users successively until an opportunity made available by the communication is no longer available or there are no further target groups of users for which the communication may be provided. In an example embodiment, the communication may be modified prior to providing the communication to at least one successive target group of users of the target groups of users. Example embodiments for providing communications to the target groups of users according to the trigger event are described in greater detail below.

In an example embodiment, the method 400 may deploy the module 302 at block 402, the module 304 at block 404, the module 306 at block 406 and the module 308 at block 408 (see FIG. 2).

Referring to FIG. 5, a method 600 in accordance with an example embodiment for target selection is shown. In an example embodiment, the method 600 may be performed at block 404 (see FIG. 4).

A first target group of users may be selected as a current target group of users at block 502. The targets for a current target group of users may then be defined at block 504.

In an example embodiment, the target group of users may include users from a contact list. The contact list may include a plurality of user identifications by one or more mechanisms of which the communications may be received. For example, the contact lists may include e-mail addresses, Instant Message (IM) user account names, Short Message Service (SMS) phone numbers, facsimile numbers, and the like. Examples of the contact lists include a site user list, a previously defined list of persons, a manually defined list of persons, users of an entire site, users of an entire community, lists imported from other applications, and the like. An example user interface for selecting the contact list is described in greater detail below.

In an example embodiment, the target group of users may include users of a contact area. The contact area may include an identification of one or more mechanisms by which the communications may be posted. For example, the contact areas may include private, semi-private and public areas on one or more sites. Examples of contact areas include a country, a city, a geographic region, an entire site, an entire community, a category, and the like. An example user interface for selecting the contact area is described in greater detail below.

In an example embodiment, the target group of users of a first contact list and/or a first contact area to a second contact list and/or a second contact area may be selected to enable migration from a smaller market to a larger market, a first market type of a second market type, and the like.

At decision block 506, the method 500 may determine whether there is a another target group of users. If there is another target group of users, the method 500 may access the another target group of users as the current target group of users at block 508 and return to block 504. If there is not another target group of users at decision block 506, the method 500 may terminate.

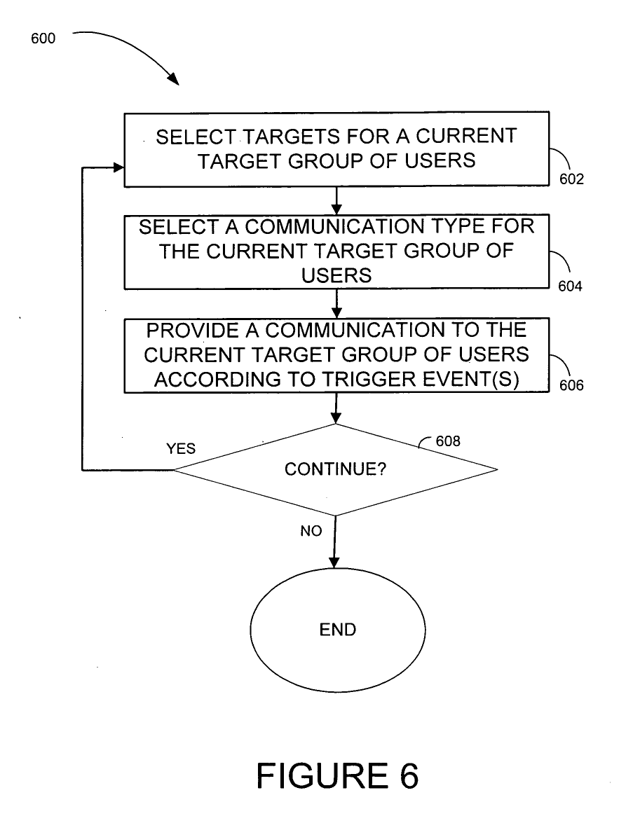

Referring to FIG. 6, a method 600 of opportunity distribution in accordance with an example embodiment is shown. In an example embodiment, the opportunity communication applications 234 (see FIG. 2) may operate the method 600.

A current target group of users may be selected at block 602. In an example embodiment, the operations of the method 500 (see FIG. 5) may be performed at the block 602.

A communication type may be selected for the current target group of users at block 604. An example embodiment for communication type selection is described in greater detail below.

A communication may be provided for the current target group of users according to one or more trigger events at block 606. Example embodiments for providing the communication for the current target group of users according to one or more triggers events are described in greater detail below.

At decision block 608, the method 600 may determine whether to continue operations. For example, the method 600 may continue operations when a trigger event occurs. If the method 600 is to continue operations, the method 600 may return to block 602. If the method is not to continue operations, the method 600 may terminate.

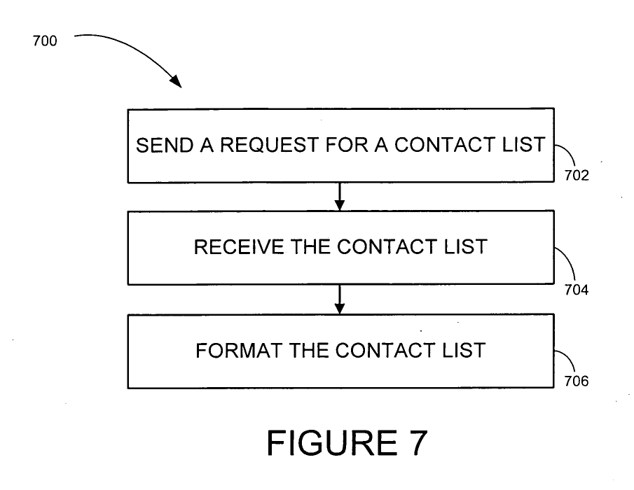

Referring to FIG. 7, a method 700 in accordance with an example embodiment for obtaining a contact list is shown. In an example embodiment, the method 700 may be performed at block 604 (see FIG. 6).

A request for the contact list may be sent to a list source at block 702. For example, the request for the contact list may be sent from a first site to a second site at which the user is a member.

The contact list may be received from the list source at block 704. For example, the second site may provide the contact list to the first site. The first site may have a relationship with second site, such that the second site provides the contact list in a desired and/or secure format.

The contact list may be formatted at block 706. For example, the first site may format the contact list received from the second site into a useable format. In an example embodiment, the contact list may be targets for a target group of users such as may be defined during the operation at block 504 (see FIG. 5). After completion the operation at block 706, the method 700 may terminate.

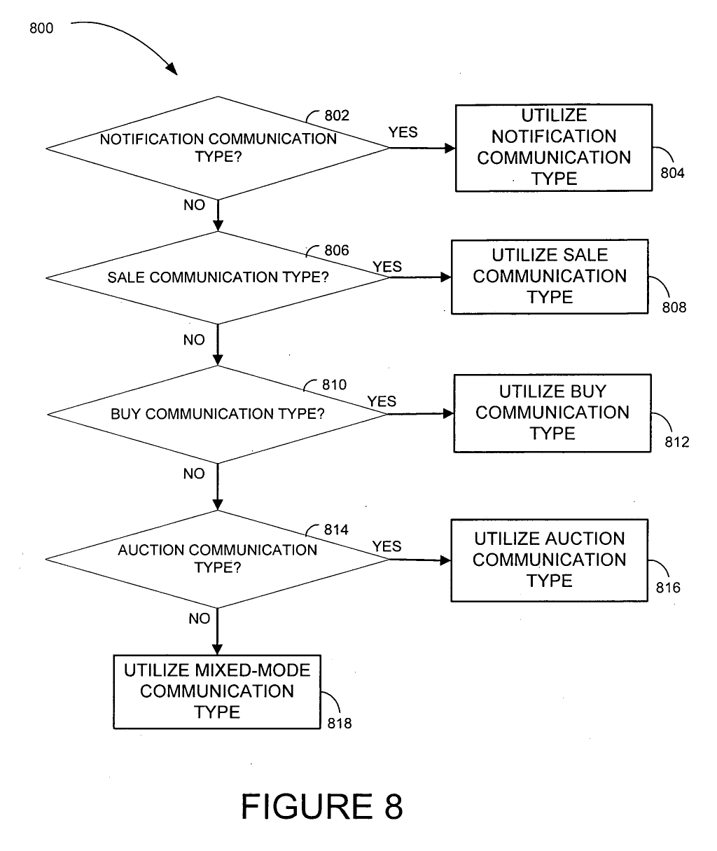

Referring to FIG. 8, a method 800 of communication type selection in accordance with an example embodiment is shown. In an example embodiment, the method 800 may be performed at block 406 (see FIG. 4). In an example embodiment, the method 800 may be performed at block 604 (see FIG. 6).

The method 800 may determine at decision block 802 whether the communication type is a notification communication type. If the communication type is the notification communication type, the method 800 at block 804 may utilize the notification communication type for the communication. For example, the notification communication type may include a message without an offer to buy, sell or auction such as a notice regarding an event, an opportunity, and the like.

At decision block 806, the method 800 may determine whether the communication type is a sale communication type. The method 800 at block 808 may utilize the sale communication type for the communication if the communication type is the sale communication type. For example, the sale communication type may include a message with an offer seeking to sell (or lease) a good/service.

The method 800 may determine at decision block 810 whether the communication type is a buy communication type. If the communication type is the buy communication type, the method 800 at block 812 may utilize the buy communication type for the communication. For example, the buy communication type may include a message with an offer seeking to buy (or lease) a good/service.

At decision block 814, a determination may be made as to whether the communication type is an auction communication type. If the communication type is of the auction communication type, the method 800 at block 808 may utilize the auction communication type for the communication. For example, the auction communication type may include a message with an offer to auction a good/service.

If the communication type is not the auction communication type at decision block 814, the method 800 at block 818 may utilize a mixed-mode communication type. For example, the mixed-mode communication type may include more than one communication type for the target groups of users. An example embodiment of defining the mixed-mode communication type is described in greater detail below.

Upon completion of the operations at block 804, block 808, block 812, block 816, or block 818, the method 800 may terminate.

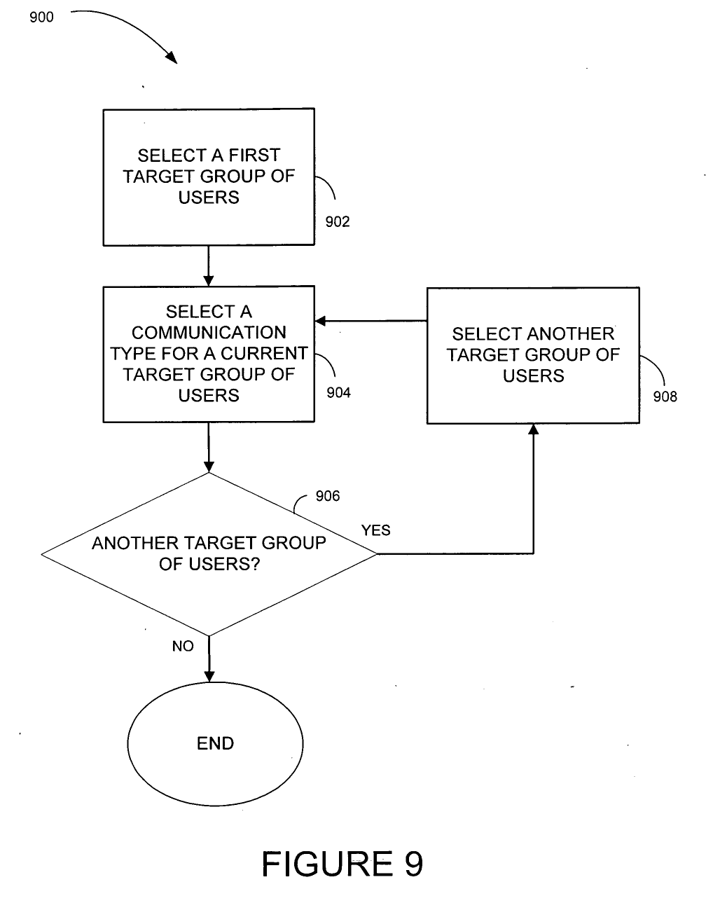

Referring to FIG. 9, a method 900 in accordance with an example embodiment for defining a mixed mode communication type is shown. In an example embodiment, the method 900 may be performed at block 818 (see FIG. 8).

A first target group of users may be selected at block 902. The communication type may be selected for a current target group of users at block 904.

At decision block 906, the method 900 may determine whether there is another target group of users. If there is another target group of users, the method 900 at block 908 may selected another target group of users and return to block 904. If there is not another target group of users at decision block 906, the method 900 may terminate.

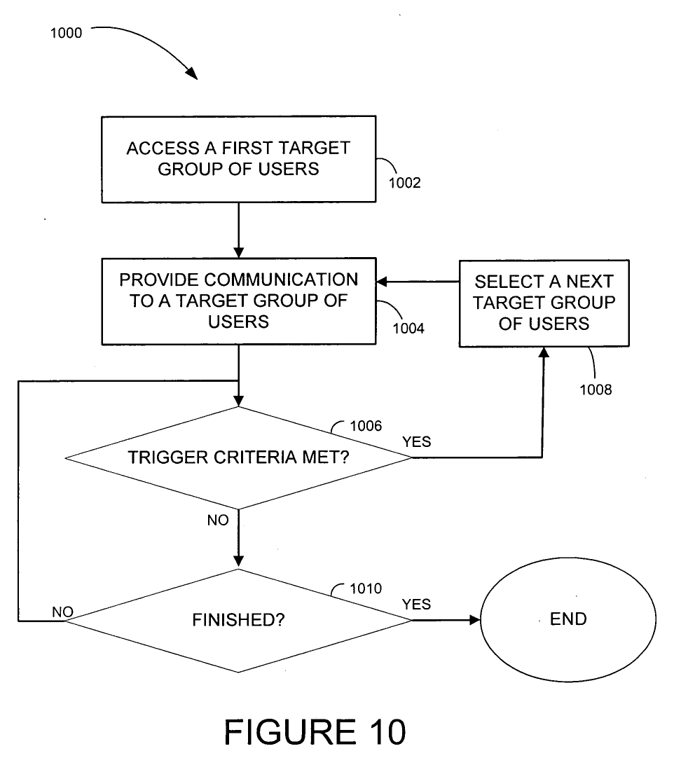

Referring to FIG. 10, a method 1000 in accordance with an example embodiment for providing communication to target groups of users according to trigger criteria is shown. In an example embodiment, the method 1000 may be performed at block 408 (see FIG. 4). In an example embodiment, the method 100 may be performed at block 606 (see FIG. 6). In an example embodiment, the method 1000 may be used when the communication type is the notification communication type, the sale communication type, the buy communication type and/or the auction communication type.

A first target group of users may be accessed at block 1002. A communication may then be provided to a current target group of users at block 1004. An example embodiment of providing the communication to the target groups of users is described in greater detail below.

At decision block 1006, the method 1000 may determine whether trigger criteria event has been met. If the trigger criteria has been met, the method 1000 at block 1008 may select another target group of users and return to block 1004. If the method 1000 determines that the trigger criteria has not been met, the method 1000 may proceed to decision block 1010.

At decision block 1010, the method 1000 may determine whether to continue operations. If operations are to continue, the method 1000 may return to decision block 1006. If operations are not to continue, the method 1000 may terminate.

In an example embodiment, the communication may continue to be available for a previous target group of users at block 1004 when the communication is made available for a current target group of users. In an example embodiment, the communication may be removed or otherwise made unavailable for a previous target group of users at block 1004 when the communication is made available for a current group of users.

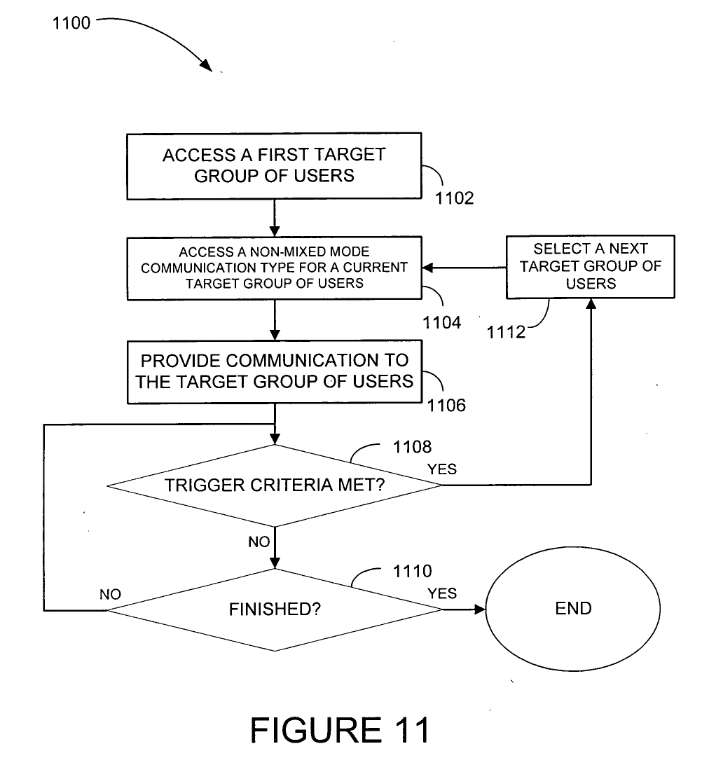

Referring to FIG. 11, a method 1100 in accordance with an example embodiment for providing communication to target groups of users according to trigger criteria is shown. In an example embodiment, the method 1100 may be performed block 408 (see FIG. 4). In an example embodiment, the method 100 may be performed at block 606 (see FIG. 6). In an example embodiment, the method 1100 may be used when the communication type is the mixed-mode communication type.

A first target group of users may be accessed at block 1102. A non-mixed-mode communication type may be accessed for a current target group of users at block 1104. The communication at block 1106 may then be provided to the current target group of users. An example embodiment of providing the communication to a target group of users is described in greater detail below.

At decision block 1108, the method 1100 may determine whether trigger criteria has been met. If the trigger criteria has been met, the method 1100 at block 1110 may access another target group of users and return to block 1104. If the method 1100 determines that the trigger criteria has not been met, the method may proceed to decision block 1110.

At decision block 1110, the method 1000 may determine whether to continue operations. If operations are to continue, the method 1100 may return to decision block 1108. If operations are not to continue, the method 1100 may terminate.

In an example embodiment, the communication may continue to be available for a previous target group of users at block 1104 when the communication is made available for a current target group of users. In an example embodiment, the communication may be removed or otherwise made unavailable for a previous target group of users at block 1104 when the communication is made available for a current group of users.

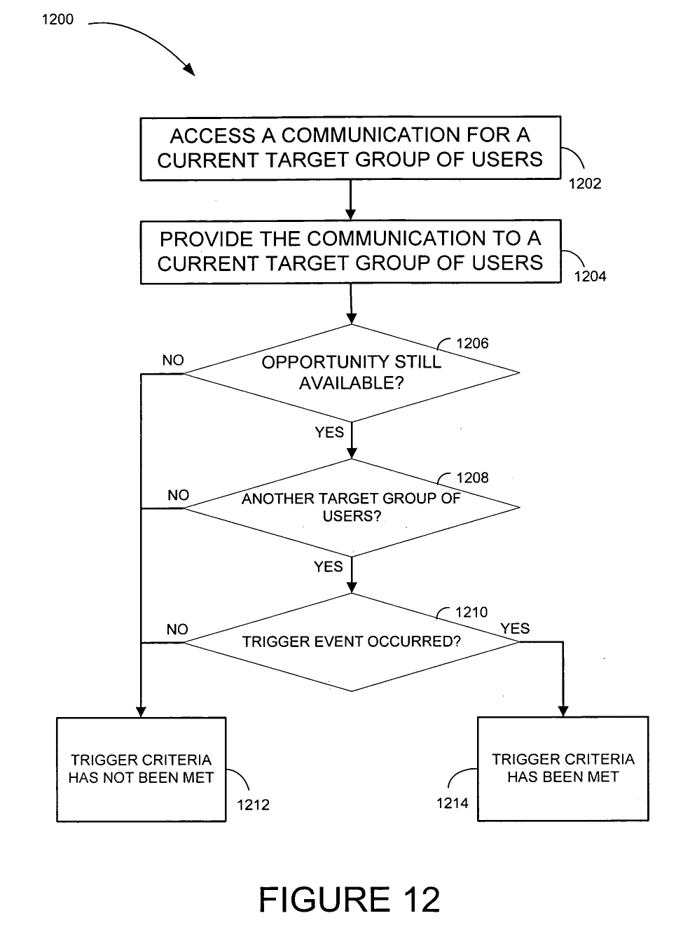

Referring to FIG. 12, a method 1200 in accordance with an example embodiment for providing communication to a target group of users is shown. In an example embodiment, the method 1200 may be performed at block 1004 (see FIG. 10). In an example embodiment, the method 1200 may be performed at block 1106 (see FIG. 11). In an example embodiment, the method 1200 may be performed at block 506 (see FIG. 5).

A communication may be accessed for a current target group of users at block 1202. The communication may then be provided to targets of the current target group of users at block 1204.

At decision block 1206, the method 1200 may determine whether an opportunity provided by the communication is still available. If the opportunity is still available, the method 1200 may proceed to decision block 1208. If the opportunity is no longer available, the method 1200 may proceed to block 1212.

The method 1200 may determine at decision block 1208 whether another target group of users is available. If another target group of users is available, the method 1200 may proceed to decision block 1210. If another target group of users is available at decision block 1208, the method 1200 may proceed to block 1212.

At decision block 1210, the method 1200 may determine whether a trigger event has occurred. In an example embodiment, the trigger event may include expiration of a time period at block 1008 before returning to block 1004. For example, the time period may enable the targets of a first target group of users to take advantage of an opportunity before the targets of a second target group of users is provided with the opportunity. The time period may be determinable and/or specifiable by a user, may be dependent on a target group of users type, and/or may vary based on a number of target groups of users used. In an example embodiment, the trigger event may enable providing the communication to a broader (or smaller) target such as an alternative or a supplemental sales channel. For example, that trading activity on a particular platform (e.g., a small market place) may be monitored and if it is determined that there is a large quantity of a particular item available within the small market (e.g., the market is flooded with the particular item), the determination may act as the trigger event, thereby triggering publication of the purchase opportunity via a broader market and/or through another channel. Examples of when other trigger events may occur include a changing in an accepted price of an item listed in the communication, an availability reduction in a number of items listed in the communication, discounting of an item listed in the communication, an item listed in the opportunity being discontinued, or an item listed in the communication is in a news story occurs.

If the trigger event has not been determined to have occurred at decision block 1210, the method 1200 may return that the trigger criteria has not been met at block 1212. For example, returning that the trigger criteria has not been met may effect the operations at decision block 1006 and/or decision block 1108 (see FIGS. 10 and 11).

If the trigger event has been determined to have occurred at decision block 1210, the method 1200 may return that the trigger criteria has not been met at block 1214. For example, returning that the trigger criteria has been met may effect the operations at decision block 1006 and/or decision block 1108.

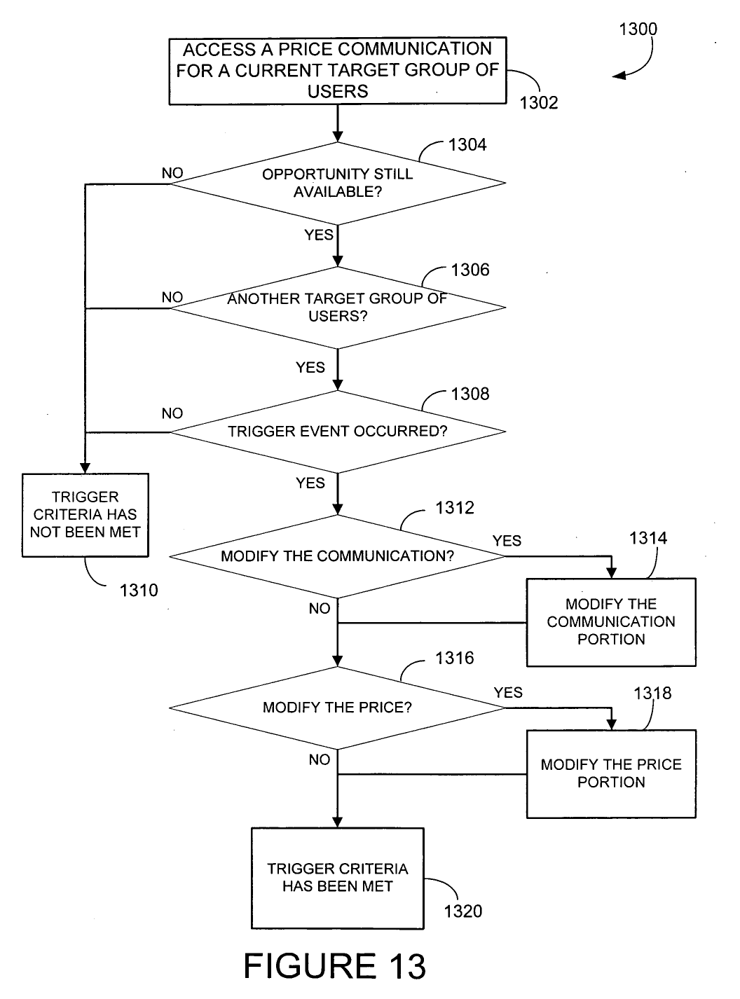

Referring to FIG. 13, a method 1300 in accordance with an example embodiment for providing price communication to a target group of users is shown. In an example embodiment, the method 1300 may be performed at block 1004 (see FIG. 10). In an example embodiment, the method 1300 may be performed at block 1106 (see FIG. 11).

A price communication may be accessed for a current target group of users at block 1302. For example, the price communication may include a communication portion and a price portion. The price communication may then be provided to the current target group of users at block 904.

At decision block 1306, the method 1300 may determine whether an opportunity provided by the price communication is still available. If the opportunity is still available, the method 1300 may proceed to decision block 1310. If the opportunity is no longer available, the method 1300 may proceed to block 1310.

The method 1300 may determine at decision block 1306 whether another target group of users is available. If another target group of users is not available, the method 1300 may proceed to block 1310. If another target group of users is available at decision block 1310, the method 1300 may proceed to decision block 1308.

At decision block 1308, the method 1300 may determine whether a trigger event has occurred. If the trigger event has not occurred, the method 1300 may return that the trigger criteria has not been met at block 1310. For example, returning that the trigger criteria has not been met may effect the operations at decision block 1006 and/or decision block 1108 (see FIGS. 10 and 11). If the trigger event has occurred, the method 1300 may proceed to decision block 1312.

The method 1300 may determine at decision block 1312 whether to modify the price communication, such that prior to providing the next target group of users a communication portion of the price communication may be altered. If the method 1300 determines to modify the price communication, the communication portion of the price communication may be modified at block 1314. If the method 1300 determines not to modify the price communication or after block 1314, the method 1300 may proceed to decision block 1316.

At decision block 1316, the method 1300 may determine whether to modify the price communication such that prior to providing the next target group of users a price portion may be altered. If the method 1300 determines to modify the price portion, the price portion of the price communication may be modified at block 1318. If the method 1300 determines not to modify the price at decision block 1316 or after block 1318, the method 1300 may return that the trigger criteria has not been met at block 1320. For example, returning that the trigger criteria has been met may effect the operations at decision block 1006 and/or decision block 1108.

After completion of the operations at block 1310 or at block 1320, the method 1300 may terminate.

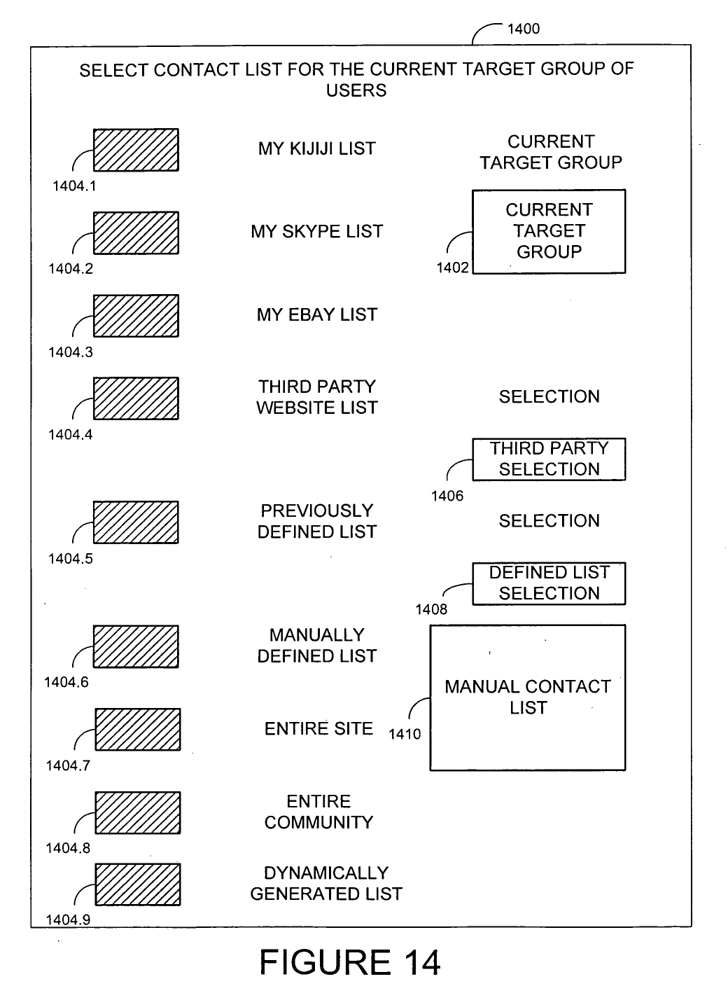

Referring to FIG. 14, a user interface 1400 in accordance with an example embodiment is shown. The user interface 1400 may include a current communications channel 1402, which may identify the current target group of users to a user.

The user interface may further include a number of contact lists 1404.1-1404.8. Any of the contact lists 1404.1-1404.9 may be selected for inclusion for a current target group of users.

In an example embodiment, a contact list 1404.1 may identify a user list of first site, such as a user list from Kijiji International Limited. A contact list 1404.2 may identify a user list of second site, such as a user list from SKYPE (e.g., a user list from the SKYPE service offered by Sykpe Limited). A contact list 1404.3 may identify a user list of third site, such as a user list from EBAY. However, it should be appreciated that a different number and/or identification of sites may be designated for inclusion on the user interface 1400. For example, the contact lists 1404.1-1404.3 may include sites that are related or owned by the same company.

In an example embodiment, a contact list 1404.4 may identify a user list from a site not immediately identified on the user interface 1400. For example, the user may use a third party selection 1406 to select a third party site from which the user seeks to access a user list.

In an example embodiment, a contact list 1404.5 may enable a user to select a previously defined list. For example, the user may use a defined list selection 1408 to select a previously defined list. In an example, embodiment, the previously defined list may include users that were manually entered.

In an example embodiment, a contact list 1404.6 may enable a user to manually define a contact list. For example, the user may select user names from a current site or e-mail addresses of persons with potential interest. For example, the user may provide a manual contact list 1410 that contains a list defined by the user.

In an example embodiment, a contact list 1404.7 may enable a user to contact all of the users of a particular site. For example, the contact list 1404.7 may be a list of the users of a site that utilize the method 400 (see FIG. 4).

In an example embodiment, a contact list 1404.8 may enable a user to contact all of the users of a community. For example, the community may be a number of sites associated with a particular ownership entity, with a common agreement, or the like.

In an example embodiment, a contact list 1404.9 may enable a dynamic generation (e.g., automatic selection) of a contact list, such as through demographic criteria, marketplace criteria and/or criteria. For example, the contact list 1404.9 may be generated based on one or more criteria including geographic location, age, income, marital status, ethnicity, religion, education level, number of children, number of pets, language spoken, travel history, employment, home ownership, citizenship, sales history, previous site activity, and the like.

It should be appreciated that other types of contact lists 1404 beyond the contact lists 1404.-1404.9 are also contemplated.

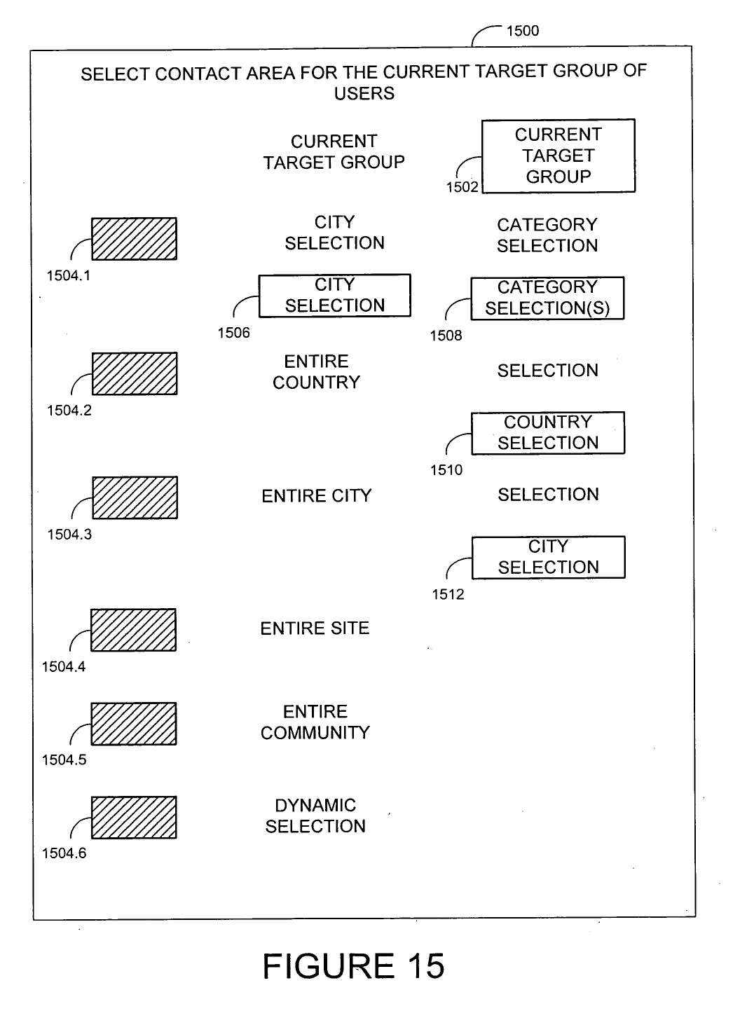

Referring to FIG. 15, a user interface 1500 in accordance with an example embodiment is shown. The user interface 1500 may include a current communications channel 1502, which may identify the current target group of users to a user.

The user interface 1500 may further include a number of contact areas 1504.1-1504.5. Any of the contact areas 1504.1-1504.6 may be selected for inclusion for a current target group of users.

In an example embodiment, a contact area 1504.1 may enable a user to make a city selection 1506 and a category selection 1508 with the city selection.

In an example embodiment, a contact area 1504.2 may enable a user to make a country selection 1510. In an example embodiment, a contact area 1504.3 may enable a user to make a city selection 1512. In an example embodiment, a contact area 1504.4 may enable a user to select contacting an entire site. In an example embodiment, a contact area 1504.5 may enable a user to select contacting an entire community.

In an example embodiment, a contact area 1405.6 may be dynamically generated, such as through demographic and/or other factors. For example, the contact area 1405.6 may be generated based on one or more factors including geographic location, age, income, marital status, ethnicity, religion, education level, number of children, number of pets, language spoken, travel history, employment, home ownership, citizenship, purchasing history, previous site activity, and the like.

It should be appreciated that other types of contact areas 1504 beyond the contact areas 1504.1-1504.6 are also contemplated.

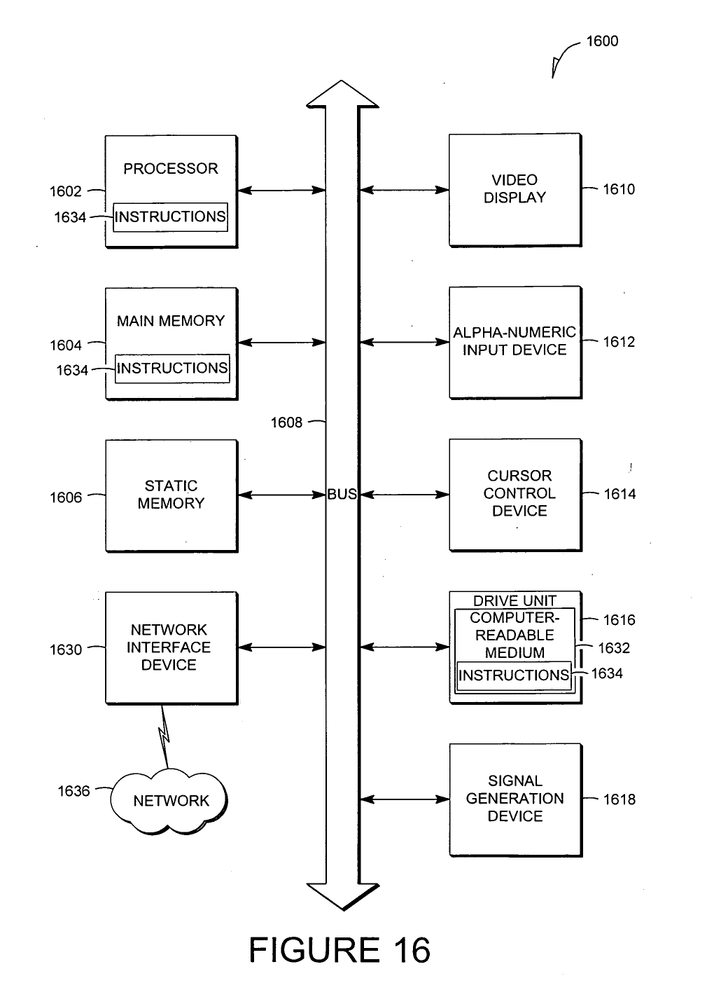

FIG. 16 shows a diagrammatic representation of machine in the exemplary form of a computer system 1600 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 1600 includes a processor 1602 (e.g., a central processing unit (CPU) a graphics processing unit (GPU) or both), a main memory 1604 and a static memory 1606, which communicate with each other via a bus 1608. The computer system 1600 may further include a video display unit 1610 (e.g., a liquid crystal display (LCD) or a cathode ray tube (CRT)). The computer system 1600 also includes an alphanumeric input device 1612 (e.g., a keyboard), a cursor control device 1614 (e.g., a mouse), a disk drive unit 1616, a signal generation device 1618 (e.g., a speaker) and a network interface device 1620.

The disk drive unit 1616 includes a machine-readable medium 1622 on which is stored one or more sets of instructions (e.g., software 1624) embodying any one or more of the methodologies or functions described herein. The software 1624 may also reside, completely or at least partially, within the main memory 1604 and/or within the processor 1602 during execution thereof by the computer system 1600, the main memory 1604 and the processor 1602 also constituting machine-readable media.

The software 1624 may further be transmitted or received over a network 1626 via the network interface device 1620.

While the machine-readable medium 1622 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

Thus, a method and system for opportunity distribution have been described. Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method comprising:
identifying respective first and second groups of users;
providing an opportunity to the first group of users;
detecting a trigger event; and
selectively providing the opportunity to the second group of users based on the detection of the trigger event.

2. The method of claim 1, wherein the identifying respective first and second groups of users includes receiving user input identifying each of the first and second groups of users.

3. The method of claim 1, wherein the identifying respective first and second groups of users includes automatically selecting the first and the second groups of users based on predetermined criteria.

4. The method of claim 3, further comprising selecting at least one of marketplace criteria or demographic criteria as the predetermined criteria.

5. The method of claim 4, further comprising selection at least one of sales history and previous site activity as the marketplace criteria.

6. The method of claim 4, further comprising selection at least one of geographic location, age, income, marital status, ethnicity, religion, education level, number of children, number of pets, language spoken, travel history, employment, home ownership, citizenship as the demographic criteria.

7. The method of claim 1, wherein the identifying respective first and second groups of users includes selecting contacts from a contact list of a list source.

8. The method of claim 1, further comprising modifying the opportunity prior to providing the opportunity to the second group of users.

9. The method of claim 1, further comprising triggering a trigger event upon expiration of a time period.

10. The method of claim 1, further comprising triggering a trigger event when at least one of a certain quantity of a particular item listed in the opportunity is at a certain price level, a changing in an accepted price of an item listed in the opportunity, an availability reduction in a number of items listed in the opportunity, discounting of an item listed in the opportunity, an item listed in the opportunity being discontinued, or an item listed in the opportunity is in a news story occurs.

11. A method comprising:
identifying respective first and second target groups of users;
providing a communication of a communication type to the first target group of users;
determining whether triggering criteria has been met; and
selectively providing the communication of the communication type to the second target group of users based on the determination of the triggering criteria.

12. The method of claim 11, further comprising selecting a price communication as the communication type.

13. The method of claim 12, further comprising modifying a price portion of the price communication prior to providing the price communication to the second group of users.

14. The method of claim 11, further comprising selecting at least one of a notification communication type, a sale communication type, a buy communication type, an auction communication type, or a mixed-mode communication type as the communication type.

15. The method of claim 11, further comprising selecting a first group of users and a second group of users as the respective first and second targets.

16. The method of claim 11, further comprising selecting a first marketplace and a second marketplace as the respective first and second targets.

17. The method of claim 11, further comprising selecting a first contact area and a second contact area as the respective first and second targets.

18. The method of claim 11, further comprising selecting a first plurality of user identifications of a first contact list and a second a plurality of user identifications of a second contact list.

19. The method of claim 11, further comprising selecting at least one of a posting or a message as the communication.

20. The method of claim 11, further comprising selecting an opportunity as the communication.

21. The method of claim 11, further comprising selecting at least one of an opportunity still being available for the second target group of users and detection of a trigger event as the triggering criteria.

22. The method of claim 21, selecting at least one expiration of a time period, providing the communication to an alternative sales channel, providing the communication to a supplemental sales channel, excess quantity of an item within a market, changing of an accepted price of an item listed in the communication, an availability reduction in a number of items listed in the communication, discounting of an item listed in the communication, an item listed in the opportunity being discontinued, or an item listed in the communication is in a news story as the trigger event.

23. An apparatus comprising:
a target selection module to select respective first and second groups of users; and
a communication provider module to provide an opportunity of a communication type to the first group of users, detect a trigger event and selectively provide the opportunity of the communication type to the second group of users based on the detection of the trigger event.

24. The apparatus of claim 23, further comprising:
A communication type selection module to select at least one of a notification communication type, a sale communication type, a buy communication type, an auction communication type, or a mixed-mode communication type as the communication type.

25. A machine-readable medium comprising instructions, which when executed by a machine, cause the machine to:
identify respective first and second groups of users;
provide an opportunity of a communication type to the first group of users;
detect a trigger event; and
selectively provide the opportunity of the communication type to the second group of users based on the detection of the trigger event.
